(19) United States
(12) Patent Application Publication
(10) Pub. No.: US 2021/0042780 A1
(43) Pub. Date: Feb. 11, 2021

(54) SUBSTANTIALLY REAL TIME CASH BACK SETTLEMENT

(71) Applicant: Apple Inc., Cupertino, CA (US)

(72) Inventors: Akila Suresh, San Jose, CA (US); Corey G. Fugman, Saratoga, CA (US); David T. Haggerty, San Francisco, CA (US); Eduardo H. Cue, Los Altos Hills, CA (US); Jarad M. Fisher, Millbrae, CA (US); Ashish Nagre, Sunnyvale, CA (US); Richard Heard, San Francisco, CA (US)

(21) Appl. No.: 16/944,976

(22) Filed: Jul. 31, 2020

Related U.S. Application Data
(60) Provisional application No. 62/882,915, filed on Aug. 5, 2019.

(51) Int. Cl. G06Q 30/02; G06Q 20/36; G06Q 20/24

(52) U.S. Cl. CPC G06Q 30/0233; G06Q 20/24; G06Q 20/3674; G06Q 30/0215

(57) ABSTRACT

The present technology provides a technological infrastructure that overcomes common problems associated with cash back rewards cards. The present invention integrates a credit card account with cash account through an electronic wallet application such that cash can be transferred directly into a user's cash account after each transaction which cash back is earned. In some embodiments, the user's cash account and a cash account associated with a business associated with a credit card can be provided by the same financial institution. The above infrastructure further allows for more efficient payment of a credit card balance, wherein when cash is transferred from the user's cash account to the business' cash account in association with a credit card balance, an immediate release of open to buy funds is affected.

### CROSS REFERENCE TO RELATED APPLICATIONS

This application claims the benefit of and/or priority to U.S. provisional application No. 62/882,915, filed on Aug. 5, 2019, which is expressly incorporated by reference herein in its entirety.

### TECHNICAL FIELD

The present technology to providing cash back rewards, and more specifically pertains to providing cash back rewards in substantially real time and directly to a cash account.

### BACKGROUND

Cash back is a type of reward mechanism that some credit cards use to encourage card holders to spend more money with the credit card. Typically, the credit card provider agrees to provide some percentage of each transaction back to the customer as “cash,” though this is somewhat of a fiction. Most often cash back refers to providing an account holder with a value of cash back earned on their credit card account statement. The credit card providers prefer that the user then use the cash back to pay their credit card statement or to convert the cash back to loyalty points on an airline or hotel brand or to a gift card. However, a minority of the cards offering cash back do allow a user to transfer the cash back to a bank account where the cash back can be turned into cash. However, these cards have restrictions on when cash back can be turned into cash. Often the amount of cash back needs to exceed a minimum amount, or a request for cash back can only be made at certain times. Additionally, the amount of cash that can be received from cash back rewards is sometimes less than the available cash back reward amount.

Another aspect of conventional cash back reward programs is that the cash back only posts to an account at the end of a billing period—when a statement is issued.

### BRIEF DESCRIPTION OF THE DRAWINGS

In order to describe the manner in which the above-recited and other advantages and features of the disclosure can be obtained, a more particular description of the principles briefly described above will be rendered by reference to specific embodiments thereof which are illustrated in the appended drawings. Understanding that these drawings depict only exemplary embodiments of the disclosure and are not, therefore, to be considered to be limiting of its scope, the principles herein are described and explained with additional specificity and detail through the use of the accompanying drawings in which:

FIG. 1 illustrates a swim lane diagram showing example communications between, and actions by, entities involved in providing cash back rewards in substantially real time and directly to a cash account in accordance with some aspects of the present technology;

FIG. 2 illustrates an example method embodiment for providing cash back rewards in substantially real time and directly to a cash account in accordance with some aspects of the present technology;

FIG. 3 illustrates a swim lane diagram showing example communications between, and actions by, entities involved in paying a credit card balance with a cash account wherein the payment is immediately reflected at the credit card provider in accordance with some aspects of the present technology;

FIG. 4A, FIG. 4B, and FIG. 4C illustrate block diagrams showing account statuses before and after transactions described herein in accordance with some aspects of the present technology;

FIG. 5 illustrates a diagram of an example computing system for use with the present technology in accordance with some aspects of the present technology.

### DESCRIPTION OF EXAMPLE EMBODIMENTS

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure.

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

As used herein, reference to actions taken in “real time” or “substantially real time” refer to actions that take place as soon as practicable. It should be appreciated that some actions or results that are described as occurring in real time or substantially real time are inherently delayed by processing of certain steps or data, or electronic communications, even though the actions or result otherwise occur immediately after an action or communication or contemporaneously with an action or communication. Reference to actions or results occurring in real time or substantially real time distinguish, or are different from, events that occur periodically, and especially different than events that occur in periods of more than one day.

As used herein, a reference to “cash back” refers to a credit card reward for spending using the credit card. Cash back amounts are reflected on a credit card statement and are under the management of a credit card provider. As used herein, a reference to “cash” refers to physical currency or to currency balances in a checking or savings account that permit spending and transfers of the currency without any restriction placed by the credit card provider.

The disclosed technology addresses the need in the art for a technology that can provide a true cash back reward. Specifically, current cash back programs don't live up to customers' expectations because customers either can't access the cash back as actual cash, or it is difficult to convert the cash back reward to cash.

There are both business reasons and technological reasons why cash back programs do not make it easy for account holders to receive cash when cash back rewards are earned.

The business reasons have to do with the credit card banks and card issuers not wanting to have to disgorge their own cash. It is better for the credit card company to run a cashback balance that, while it might be used to reduce the amount a customer pays the bank backing the credit card account, it doesn't result in actual disbursements of bank funds. Additionally, some cash back programs offer lots of choices of what to do with the earned cash back, and the cash back is worth different amounts depending on the option chosen. Because of this, credit cards might not want to automatically transfer cash to a card holder, and instead prefer the card holder to make explicit choices about how to handle the cash back reward.

The technological reasons have to do with the infrastructure that supports the credit card banking system. First, credit cards don't process cash back rewards after each transaction, or even every day, so even though a card holder has performed the transaction to earn the cash back reward, the credit cards don't have systems to determine cash back reward more often than once a billing period. Additionally, most transfers that happen between accounts at two different banks need to go through a clearing process whereby the money is held until the transaction fully clears. These technological hurdles mean that it isn't possible for a credit card to provide cash to a card holder when they earn the cash back reward.

There are other reasons why cash back programs do not make it easy for account holders to receive actual cash when it is earned. In some cases, a credit card provider doesn't want to have to maintain infrastructure to routinely transfer cash to a card holder. This would require securely storing account information for where the cash should be sent.

Card holders, on the other hand, want access to their cash back when it is earned, and would especially prefer to receive the cash back reward as cash. For example, a user that has made a large purchase on their credit card might be in line for a sizable amount of cash back. Rather than apply the cash back to the purchase, they might desire to have cash for other uses.

The present technology solves these problems by providing a system that can calculate cash back rewards contemporaneously or immediately after a transaction takes place on the credit card. The present technology can further immediately transfer the earned amounts to a bank account associated with the user so that the user can immediately spend the money. The user does not need to wait for a transfer, such as an ACH transfer to clear.

As described herein, one aspect of the present technology is the gathering and use of data available from various sources to provide substantially real time access to cash back rewards. The present disclosure contemplates that in some instances, this gathered data may include personal information data that uniquely identifies or can be used to contact or locate a specific person. Such personal information data can include demographic data, location-based data, telephone numbers, email addresses, twitter ID's, home addresses, data or records relating to a user's health or level of fitness (e.g., vital signs measurements, medication information, exercise information), date of birth, or any other identifying or personal information.

The present disclosure recognizes that the use of such personal information data, in the present technology, can be used to the benefit of users. For example, the personal information data can be used to provide substantially real time access to cash back rewards.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users and should be updated as the collection and/or use of data changes. Personal information from users should be collected for legitimate and reasonable uses of the entity and not shared or sold outside of those legitimate uses. Further, such collection/sharing should occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the US, collection of or access to certain health data may be governed by federal and/or state laws, such as the Health Insurance Portability and Accountability Act (HIPAA); whereas health data in other countries may be subject to other regulations and policies and should be handled accordingly. Hence different privacy practices should be maintained for different personal data types in each country.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the case of customized payment options on financial statements, the present technology can be configured to allow users to select to “opt-in” or “opt out” of participation in the collection of personal information data during registration for services or anytime thereafter. In addition to providing “opt-in” and “opt out” options, the present disclosure contemplates providing notifications relating to the access or use of personal information. For instance, a user may be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health-related applications, data de-identification can be used to protect a user's privacy. De-identification may be facilitated, when appropriate, by removing specific identifiers (e.g., date of birth, etc.), controlling the amount or specificity of data stored (e.g., collecting location data a city level rather than at an address level), controlling how data is stored (e.g., aggregating data across users), and/or other methods.

Therefore, although the present disclosure broadly covers the use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, providing substantially real time access to cash back rewards can be handled based on non-personal information data or a bare minimum amount of personal information, such as the content being requested by the device associated with a user, other non-personal information available to the financial statement server, or publicly available information.

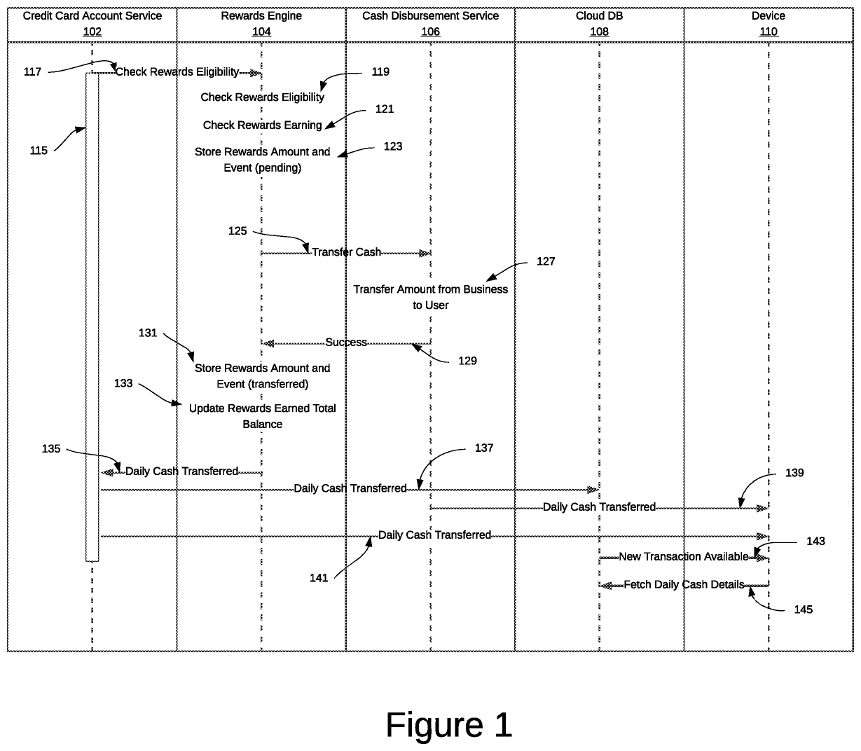

FIG. 1 illustrates a method to provide substantially real time access to cash converted from a cash back reward. In particular FIG. 1 illustrates communications between credit card account service 102, rewards engine 104, cash disbursement service 106, cloud database 108, and portable computing device 110 that take place in order to determine that a cash back reward has been earned and to cause a transfer of the cash back reward to a cash account associated with a cardholder.

Credit card account service 102 represents one or more entities responsible for handling a credit card transaction. For example, credit card account service 102 can include entities such as a card issuer, and/or card processor for a credit card. Credit card account service 102 is responsible for receiving information regarding a transaction, authorizing the transaction, clearing a transaction, and recording information about transactions.

Rewards engine 104 represents a service that may run on a server of an entity that is part of the credit card account service 102 or can be provided by a separate entity. Rewards engine 104 can be responsible for establishing awards criteria and rules, and for calculating the amount of the award owed to a credit card holder. In some embodiments, rewards engine 104 is a third party entity with respect to the credit card account service 102 and/or the cash disbursement service 106. In some embodiments, rewards engine 104 can be provided by an entity that provides a digital wallet on portable computing device 110.

Cash disbursement service 106 can be a service that is responsible for moving cash between an account of a business entity that is responsible for paying out cash back rewards as cash and a cash account associated with the credit card holder. In some embodiments, the business entity that is responsible for paying out cash back rewards can be a credit card provider, while in some embodiments, the business entity that is responsible for paying out cash back rewards can be a different entity then the credit card provider.

Cloud database 108 can be a database provided by an entity that provides a software wallet application to device 110. Cloud database 108 can store information regarding one or more financial transaction cards stored in the wallet application. For example, cloud database 108 can store information regarding transactions and balances related to a credit card and can store information regarding transactions and balances related to a cash account.

As used herein, a cash account is any bank account that can store cash balances on behalf of a user, and from which the user can withdraw cash or cash equivalents such as checks. For example, a cash account may be a checking account or a savings account.

Each of the entities represented in FIG. 1 can communicate with each other through one or more application program interfaces (APIs).

The method illustrated in FIG. 1 can begin when credit card account service 102 processes 115 a transaction activity for a credit card account. The processing 115 of the transaction activity is represented by a bar to illustrate that processing 115 of the transaction activities can involve a series of steps that can take some time. For example, processing 115 of the transaction activities can include receiving a request to authorize a transaction, determining that the transaction can be authorized, sending a communication to authorize the transaction, and clearing the transaction, etc. Upon the detection of any of these transaction activities, credit card account service 102 can send 117 a notification to check rewards eligibility to rewards engine 104.

The notification 117 to check rewards eligibility can include information identifying the credit card account, a merchant code, a merchant category, an amount of the transaction, etc.

Rewards engine 104 can use the information in the notification 117 and reward rules and criteria established at rewards engine 104 to check rewards eligibility 119 and to determine 121 an amount of the award earned by the credit card holder based on the particular transaction activity. Rewards engine 104 can further store the amount of the determined reward and record the cash back event as pending 123.

In addition to determining whether the credit card account holder is eligible for a reward 119, and determining how much of an award 121, rewards engine 104 is further able to determine that the credit card account holder also has a cash account that is eligible to receive the near real time transfers of cash back rewards. Rewards engine 104 can determine the existence of a cash account by storing a record of accounts associated with a user ID. Therefore, when credit card account service 102 sends a notification to rewards engine 104, rewards engine can look up the user ID associated with the credit card account, and can then determine if any other accounts are stored in association with the user account.

In some embodiments, neither the credit card account service 102 nor the cash disbursement service 106 have access to information about any user account other than the user account they manage. A user account with credit card account service 102 can have its own identifier for its user credit account, and a user account with cash disbursement service 106 can have its own identifier for its user cast account.

Portable computing device 110 can include information regarding a user account associated with a digital wallet on device 110, and the digital wallet can store account identifiers for the credit account and the cash account. Cloud database 108 can also be aware of all three identifiers (user account ID associated with digital wallet, credit card account ID, cash account ID). Importantly, neither portable computing device 110 nor cloud database 108 ever send an ID to a service other than the ID specific to that service.

In some embodiments, a cash account is eligible to receive the near real time transfers of cash back rewards when the cash account is provided by the same cash disbursement service 106 as the account responsible for paying out cash back rewards. In some embodiments, the cash account is eligible to receive the near time transfers of cash back rewards when the cash account is configured to receive direct transfers from the account responsible for paying out cash back rewards.

Rewards engine 104 can further send a notification 125 to transfer cash to cash disbursement service 106, and cash disbursement service 106 can receive the notification. Notification 125 to transfer cash to cash disbursement service 106 can include a reference ID that establishes a reference number for the particular transfer of a cash back reward by cash disbursement service 106, and an identification of the credit card holder or cash account associated with the credit card holder, and an amount to be transferred. The notification 125 can also be signed by rewards engine 104 so that cash disbursement service 106 can determine that the notification is authentic.

In response to receiving the notification to transfer the cash back reward 125, cash disbursement service 106 can transfer 127 the amount from a cash account of the entity responsible for paying out cash back rewards to the cash account of the credit card holder. Cash disbursement service 106 can then notify rewards engine 104 of the successful transaction 129.

Rewards engine 104 can then store 131 a record of the cash back amount that was transferred and update 133 a balance reflecting the total amount of cash back earned for a specified period.

Rewards engine 104 can notify 135 credit card account service 102 that the cash back award was transferred. Credit card account service 102 can then send a notification 137 to cloud database 108 that the cash back award was transferred.

Cash disbursement service 106 also sends notification 139 to cardholder device 110 indicating that the cash back award was transferred. Notification 139 includes a reference ID of the cash back reward transfer, and an amount of the reward transfer. Similarly, credit card account service 102 sends notification 141 to cardholder device 110 indicating that cash back award was transferred. Notification 141 also includes the reference ID of the cash back reward transfer, and an amount of the reward transfer, and further includes information regarding the transaction that triggered the cash back reward transfer.

Cloud database 108 also sends a notification 143 notifying device 110 that a new transaction is available and in response device 110 requests 145 details regarding the cash back transfer.

Rewards engine 104 can further perform a daily reconciliation to confirm that all rewards were transferred appropriately. Rewards engine can determine a total amount of cash transfers that should have occurred during the day based on the transaction activity, and determine a total amount of confirmed cash transfers during the day. Rewards engine can compare the two amounts are equal to confirm that the total amount of cash transfers that should have occurred equals the total amount of confirmed cash transfers that occurred during the day.

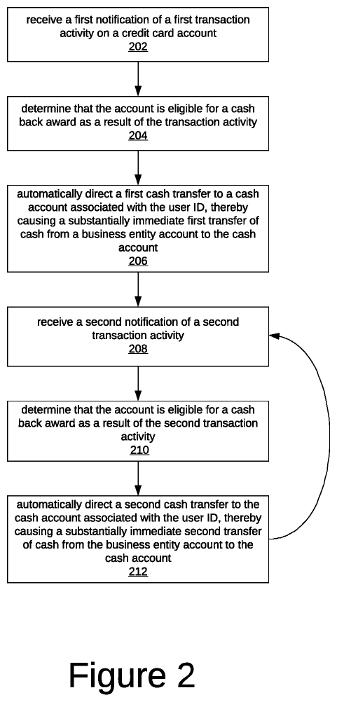

FIG. 2 illustrates another example embodiment for providing cash back rewards in substantially real time and directly to a cash account. FIG. 2 emphasizes the aspect of the present technology that cash back transfers are conducted in substantially real time following a transaction in which the cash back reward is earned.

FIG. 2 begins when rewards engine 104 receives 202 a first notification of a first transaction activity on a credit card account. In response to receiving 202 the first notification, rewards engine 104 can determine 204 that the credit card account is eligible for a cash back award as a result of the transaction activity. Rewards engine 104 can automatically direct 206 the first cash transfer to a cash account associated with the user ID of the credit card account by notifying cash disbursement service 106 to make the first cash transfer related to the first transaction activity.

Rewards engine 104 can direct 206 the first cash transfer within a first period after receiving the notification 202 of the first transaction activity. The first period can be just enough time for rewards engine 104 to determine that the account has earned a reward. In some embodiments, steps 202, 204, and 206 occur as quickly as can be processed. In some embodiments, steps 202, 204, and 206 occur hourly, or at least daily.

Subsequently rewards engine 104 can receive 208 a notification of a second transaction activity. In response to receiving 208 the second notification, rewards engine 104 can determine 210 that the credit card account is eligible for a cash back award as a result of the second transaction activity. Rewards engine can then automatically direct 212 a second cash transfer to the cash account associated with the user ID of the credit card account by notifying cash disbursement service 106 to make the second cash transfer related to the second transaction activity.

These steps can be repeated for every notification of a new transaction activity.

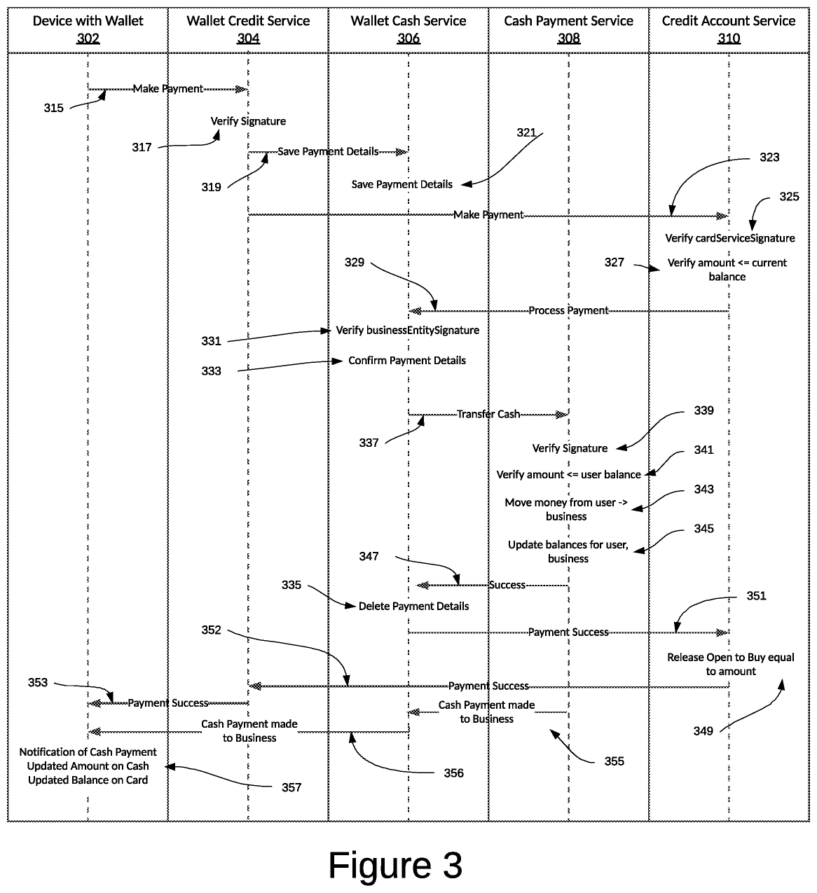

FIG. 3 illustrates an embodiment for paying at least a portion of a credit card balance using cash from a cash account where the transfer of cash to the credit card can occur immediately and be reflected immediately in the credit card balance. Just as the present technology is useful for the substantially real time transfer and receipt of a cash back reward, the present technology can be useful for the substantially real time transfer and receipt of cash to a credit card account.

FIG. 3 illustrates communications between portable computing device 302 having a digital wallet application executing thereon. The digital wallet application can be used to utilize and manage a credit card and a cash card. Each of the credit card and the cash card rely on cloud-based infrastructure to utilize the respective cards in NFC transactions and to receive updates regarding account balances and activities. Specifically, a credit card relies on wallet credit service 304, and a cash card relies on wallet cash service 306. Both the wallet credit service 304 and the wallet cash service 306 are cloud-based services managed by the provider of the digital wallet application.

Both the credit card and the cash card also rely upon a financial institution to process transactions taking place involving the respective cards. Cash payment service 308 is a service on a server of a financial institution that processes cash card transactions, and transactions for related accounts, and is the authoritative source for information regarding the cash account. Credit account service 310 is a service on a server of a financial institution that processes credit card transactions, and is the authoritative source for information regarding the credit account.

Each of the entities represented in FIG. 3 can communicate with each other through one or more application program interfaces (APIs).

FIG. 3 begins when a user operates portable computing device 302 to provide an input in a user interface indicating that the user would like to make a payment from the cash account to pay down a credit card balance. The portable computing device can determine that the user is allowed to authorize the payment using a biometric authentication to authenticate the user operating portable computing device 302.

Portable computing device 302 can then send a notification 315 to wallet credit service 304 indicating that the user would like to make a payment of a specified amount to pay down a credit card balance. Notification 315 can also include a reference ID for the transaction and notification 315, and can include a cryptographic code related to the biometric authentication of the user, and the notification can be digitally signed by portable computing device 302. In some embodiments, the digital signature can include portions of the cryptographic code related to the biometric authentication of the user.

After receiving notification 315 wallet credit service 304 can verify the digital signature received with notification 315 to determine that notification 315 is authentic.

Wallet credit service 304 can send a message 319 to wallet cash service 306 to save payment details, which is performed at step 321. In some embodiments the payment details can include an amount, a transaction ID, a timestamp, etc.

Wallet credit service 304 can send a digitally signed notification 323 to credit account service 310 informing credit account service 310 that the user would like to make a payment using their cash account. Signed notification 323 can include the reference ID of the transaction, the amount of cash to be transferred, and the notification 323 can be signed by the wallet credit service 304.

In some embodiments, credit account service 310 may verify 327 that the amount that the user requested to pay is less than the current credit balance. In some embodiments, credit account service 310 does not permit the user to pay more than an outstanding balance.

Credit account service 310 can verify 325 the digital signature in a digitally signed notification 323, and upon verification can send a request 329 to wallet cash service 306 to process the payment in the amount specified in signed notification 323. Request 329 can include a user ID, the reference ID of the transaction the amount, and can be digitally signed by credit account service 310.

After receiving the request 329 to process the payment, wallet cash service 306 can verify 331 the digital signature in request 329, and confirm payment details 333. The payment details are confirmed 333 against the payment details saved at step 321. This serves to protect against fraudulent requests to process payments. Then wallet cash service 306 can send a notification 337 instructing cash payment service 308 to transfer cash from the account associated with the user to an account associated with credit card. Notification 337 can include information that identifies the user, that identifies the business entity associated with the credit card that will receive the funds, the transaction reference ID, the amount of the transaction, and a digital signature of wallet cash service 306.

Upon receiving notification 337, cash payment service 308 can verify 339 the signature of wallet cash service 306 in notification 337, can verify 341 that there are enough funds in the user's account to cover the transaction, can transfer 343 money from the user account to the business entity account associated with the credit card, and update 345 account balances for both the user and the business entity.

Cash payment service 308 can send a notification 347 informing wallet cash service 306 of the successful transfer of funds. After receiving the payment success notification 347, wallet cash service 347 can delete 335 the payment details that were saved at 321. This serves to protect against replay attacks by removing the predicate saved payment details necessary to transfer funds right after funds have been transferred.

Wallet cash service 306 can notify 351 credit account service 310 of the successful payment, and, in turn, credit account service 310 can immediately release an “open to buy” 349 on the user's credit card account equal to the amount of cash transferred from the user account to the business entity account. Open to buy refers to the availability of credit to be used in a transaction. In the present technology, the paid credit card balance can immediately be available to use for future purchases.

In some embodiments, the immediate release of the open to buy is made possible by the immediate transfer of funds from the user account to the business entity account. Normally such transactions take time to clear, and so the open to buy is delayed. In some embodiments, the immediate release of the open to buy can be predicated on a trust level that the credit card account service 310 has in the user account at the cash payment service. Such trust can be based on a history of reliable payment, an amount of payment compared to a credit maximum, a known cash balance in the user account at the cash payment service, or other factors.

Credit card account service 310 can send a payment success notification 352 to wallet credit service 304 that identifies the user and the amount of the successful payment. Wallet credit service 304 in turn can send a payment success notification 353 to the portable computing device 302 and the wallet application executing thereon.

Cash payment service 308 also informs 355 wallet cash service 306, which in turn notifies 356 portable computing device 302 with the wallet application of the cash payment made to the credit card business entity.

Upon receiving notifications 353 and 355 the wallet application on portable computing device 302 can present notifications 357 on portable computing device 302 of the cash payment and of an updated balance on the cash card account.

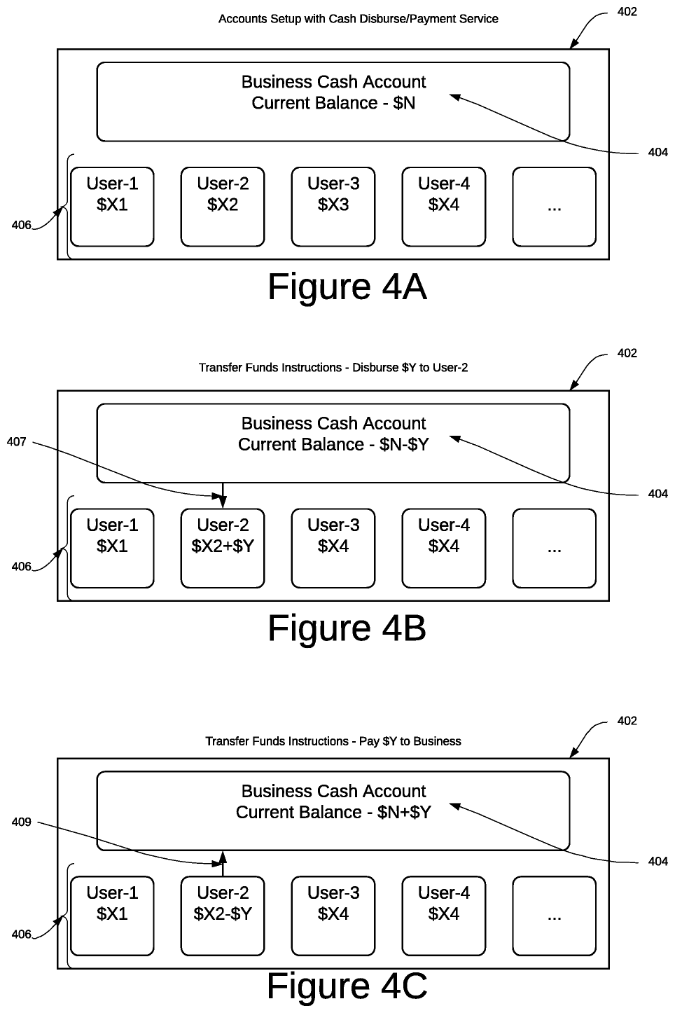

FIGS. 4A, 4B, 4C illustrates example states of a Business cash account 404 and of the plurality of user cash accounts 406 at a common bank 402.

FIG. 4A shows Business cash account 404 with a cash balance of $N, and User 2 has a cash balance of $X2.

FIG. 4B shows a transfer of a cashback award from Business cash account to a user account. Such a transfer is conducted in accordance with the embodiments illustrated in FIG. 1 and FIG. 2 where a reward service determines that a cash back reward has been earned and sends instructions to transfer the amount $Y of the cashback award to a user account—in this case, the account of User 2. Bank 402 can subtract the amount $Y of the cashback award from the balance of Business cash account 404 and transfer 407 the amount $Y of the cashback award to the account of User 2.

FIG. 4C shows a transfer from a user account to Business cash account 404. Such a transfer is conducted in accordance with the embodiment illustrated in FIG. 3. Bank 402 can subtract the payment amount $Y from the account of User 2 and transfer 409 the amount $Y to the business cash account.

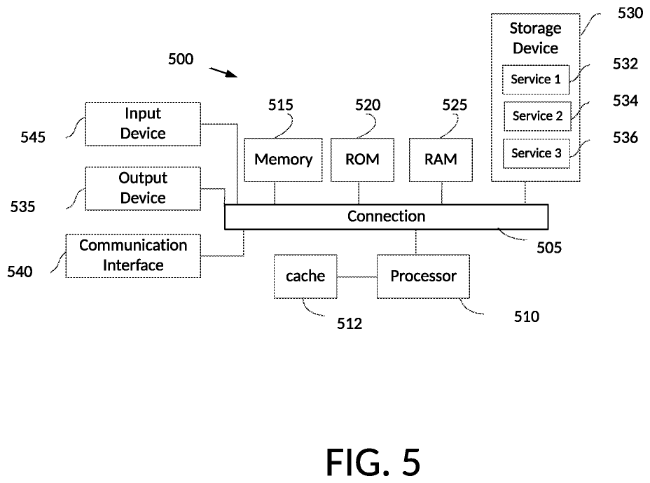

FIG. 5 shows an example of computing system 500, which can be for example any computing device making up any device, system, or service represented in the preceding figures or any component thereof in which the components of the system are in communication with each other using connection 505. Connection 505 can be a physical connection via a bus, or a direct connection into processor 510, such as in a chipset architecture. Connection 505 can also be a virtual connection, networked connection, or logical connection.

In some embodiments, computing system 500 is a distributed system in which the functions described in this disclosure can be distributed within a datacenter, multiple datacenters, a peer network, etc. In some embodiments, one or more of the described system components represents many such components each performing some or all of the function for which the component is described. In some embodiments, the components can be physical or virtual devices.

Example system 500 includes at least one processing unit (CPU or processor) 510 and connection 505 that couples various system components including system memory 515, such as read only memory (ROM) 520 and random access memory (RAM) 525 to processor 510. Computing system 500 can include a cache of high-speed memory 512 connected directly with, in close proximity to, or integrated as part of processor 510.

Processor 510 can include any general purpose processor and a hardware service or software service, such as services 532, 534, and 536 stored in storage device 530, configured to control processor 510 as well as a special-purpose processor where software instructions are incorporated into the actual processor design. Processor 510 may essentially be a completely self-contained computing system, containing multiple cores or processors, a bus, memory controller, cache, etc. A multi-core processor may be symmetric or asymmetric.

To enable user interaction, computing system 500 includes an input device 545, which can represent any number of input mechanisms, such as a microphone for speech, a touch-sensitive screen for gesture or graphical input, keyboard, mouse, motion input, speech, etc. Computing system 500 can also include output device 535, which can be one or more of a number of output mechanisms known to those of skill in the art. In some instances, multimodal systems can enable a user to provide multiple types of input/output to communicate with computing system 500. Computing system 500 can include communications interface 540, which can generally govern and manage the user input and system output. There is no restriction on operating on any particular hardware arrangement and therefore the basic features here may easily be substituted for improved hardware or firmware arrangements as they are developed.

Storage device 530 can be a non-volatile memory device and can be a hard disk or other types of computer readable media which can store data that are accessible by a computer, such as magnetic cassettes, flash memory cards, solid state memory devices, digital versatile disks, cartridges, random access memories (RAMs), read only memory (ROM), and/or some combination of these devices.

The storage device 530 can include software services, servers, services, etc., that when the code that defines such software is executed by the processor 510, it causes the system to perform a function. In some embodiments, a hardware service that performs a particular function can include the software component stored in a computer-readable medium in connection with the necessary hardware components, such as processor 510, connection 505, output device 535, etc., to carry out the function.

For clarity of explanation, in some instances the present technology may be presented as including individual functional blocks including functional blocks comprising devices, device components, steps or routines in a method embodied in software, or combinations of hardware and software.

Any of the steps, operations, functions, or processes described herein may be performed or implemented by a combination of hardware and software services or services, alone or in combination with other devices. In some embodiments, a service can be software that resides in memory of a client device and/or one or more servers of a content management system and perform one or more functions when a processor executes the software associated with the service. In some embodiments, a service is a program, or a collection of programs that carry out a specific function. In some embodiments, a service can be considered a server. The memory can be a non-transitory computer-readable medium.

In some embodiments, the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer readable media. Such instructions can comprise, for example, instructions and data which cause or otherwise configure a general purpose computer, special purpose computer, or special purpose processing device to perform a certain function or group of functions. Portions of computer resources used can be accessible over a network. The computer executable instructions may be, for example, binaries, intermediate format instructions such as assembly language, firmware, or source code. Examples of computer-readable media that may be used to store instructions, information used, and/or information created during methods according to described examples include magnetic or optical disks, solid state memory devices, flash memory, USB devices provided with non-volatile memory, networked storage devices, and so on.

Devices implementing methods according to these disclosures can comprise hardware, firmware and/or software, and can take any of a variety of form factors. Typical examples of such form factors include servers, laptops, smart phones, small form factor personal computers, personal digital assistants, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

Although a variety of examples and other information was used to explain aspects within the scope of the appended claims, no limitation of the claims should be implied based on particular features or arrangements in such examples, as one of ordinary skill would be able to use these examples to derive a wide variety of implementations. Further and although some subject matter may have been described in language specific to examples of structural features and/or method steps, it is to be understood that the subject matter defined in the appended claims is not necessarily limited to these described features or acts. For example, such functionality can be distributed differently or performed in components other than those identified herein. Rather, the described features and steps are disclosed as examples of components of systems and methods within the scope of the appended claims.

1. A computer-readable medium comprising computer-executable instructions stored thereon, when executed the computer-executable instructions are effective to cause a computing system to:
receive a notification of a transaction activity on a credit card account, the notification including an account identifier, a transaction category, and an amount, the credit card account being associated with a user ID;
determine that the credit card account is eligible for a cash back award as a result of the transaction activity; and
automatically direct a cash transfer by a cash disbursement service to a cash account associated with the user ID, thereby causing a substantially immediate transfer of cash from a business entity account to the cash account.

2. The computer-readable medium of claim 1, wherein the instructions to automatically direct the cash transfer to the cash account occurs for each transaction activity on the credit card account.

3. The computer-readable medium of claim 1, wherein the instructions to automatically direct the cash transfer to the cash account occurs within a first period of receiving the notification of the transaction activity on the credit card account, wherein the first period is less than a credit card account statement period.

4. The computer-readable medium of claim 1, wherein the instructions to automatically direct the cash transfer to the cash account are effective to cause the computing system to:
send a communication to the business entity account identifying an amount to transfer, a transaction reference ID, and an identification of the cash account.

5. The computer-readable medium of claim 3, wherein the instructions are effective to cause the computing system to:
perform a reconciliation process at an end of a second period, wherein the second period is greater than the first period, but less than the credit card account statement period, the reconciliation process is defined by the instructions that are effective to:
for all transaction activity occurring within the second period, determine a total amount of cash transfers that should have occurred during the second period based on the transaction activity;
determine a total amount of confirmed cash transfers during the second period; and
confirm that the total amount of cash transfers that should have occurred equals the total amount of confirmed cash transfers during the second period.

6. The computer-readable medium of claim 1, wherein the instructions to determine that the account is eligible for the cash back award further include instructions effective to cause the computing system to:
determine an existence of a cash account by storing a record of accounts associated with a user ID; and
determine that the cash account is provided by a cash disbursement service that is the same as the business entity account.

7. The computer-readable medium of claim 1, wherein the instructions to automatically direct the cash transfer to the cash account associated with the user ID is includes instructions to sign a communication by a rewards engine to the cash disbursement service instructing the cash disbursement service to automatically direct the cash transfer to the cash account associated with the user ID.

8. A system including an electronic wallet comprising:
at least one processor; and
at computer-readable medium storing computer-executable instructions which, when executed, the computer-executable instructions are effective to cause the at least one processor to:
receive, a request to pay at least a portion of a credit card balance with cash from a cash account, the request identifying a credit card account, an amount of payment, a cryptographic code that is related to biometric data of a user having the cash account, and a transaction ID;
send payment details to a credit card account service that manages the credit card balance, the payment details including the transaction ID, and the amount of payment;
receive, from the credit card account service, a request to process the payment, the request including the transaction ID;
confirm that the transaction ID is associated with an approved request to pay the at least the portion of the credit card balance;
instruct a cash account associated with the user to transfer the amount of payment to the credit card account service, thereby the amount of payment is transferred in a transaction characterized by a substantially real time release of an open to buy in the amount of the payment; and
receive a confirmation of a successful transaction.

9. The system of claim 8, wherein the electronic wallet includes a credit service and a cash service.

10. The system of claim 8, wherein after the receipt of the request to pay the at least the portion of the credit card balance, the instructions are further effective to cause the at least one processor to:
determine that the cash account associated with the user and a cash account associated with the credit card account service are managed by a same financial institution.

11. The system of claim 8, wherein after the receipt of the request to pay the at least the portion of the credit card balance, the instructions are further effective to cause the at least one processor to:
save the payment details indicating the payment amount and the transaction ID; and
after the receipt of the confirmation of the successful transaction, delete the saved payment details.

12. The system of claim 8, wherein the instruction to the cash account associated with the user to transfer the amount of payment to the credit card account service includes at least information the transaction ID, the amount of the transaction, and a digital signature of wallet cash service.

13. The system of claim 11, wherein the instructions to confirm that the transfer ID is associated with the approved request to pay the at least the portion of the credit card balance includes checking that the information received in the request from the credit card account service match the saved payment details indicating the payment amount and the transaction ID.

14. The system of claim 8, wherein after the receipt of the confirmation of the successful transaction by the electronic wallet, the instructions are further effective to cause the at least one processor to:
inform the credit card account service that the payment was successful, which triggers the credit card account service to release the open to buy in the amount of the payment.

15. A method comprising:
receiving a first notification of a first transaction activity on a credit card account, the first notification including an account identifier, a first transaction category, and a first amount, the credit card account being associated with a user ID;
determine that the credit card account is eligible for a cash back award as a result of the transaction activity;
automatically direct a first cash transfer to a cash account associated with the user ID, thereby causing a substantially immediate first transfer of cash from a business entity account to the cash account;
receiving a second notification of a second transaction activity, the notification including the account identifier, a second transaction category, and a second amount;
determining that the account is eligible for a cash back award as a result of the second transaction activity; and
automatically direct a second cash transfer to the cash account associated with the user ID, thereby causing a substantially immediate second transfer of cash from the business entity account to the cash account.

16. The method of claim 15, wherein the automatically directing the first cash transfer to the cash account occurs within a first period of receiving the first notification of the first transaction activity on the credit card account, wherein the first period is less than a credit card account statement period.

17. The method of claim 15, the automatically directing the first cash transfer to the cash account comprises:
sending a communication to the business entity account identifying an amount to transfer, a transaction reference ID, and an identification of the cash account.

18. The method of claim 16, comprising:
performing a reconciliation process at an end of a second period, wherein the second period is greater than the first period, but less than the credit card account statement period, the reconciliation process comprises:
for all transaction activity occurring within the second period, determining a total amount of cash transfers that should have occurred during the second period based on the transaction activity;
determining a total amount of confirmed cash transfers during the second period; and
confirming that the total amount of cash transfers that should have occurred equals the total amount of confirmed cash transfers during the second period.

19. The method of claim 15, wherein the determining that the account is eligible for the cash back award comprises:
determining an existence of a cash account by storing a record of accounts associated with a user ID; and
determining that the cash account is provided by a cash disbursement service that is the same as the business entity account.

20. The method of claim 15, wherein the automatically directing the cash transfer to the cash account associated with the user ID comprises:
signing a communication by a rewards engine to a cash disbursement service instructing the cash disbursement service to automatically direct the cash transfer to the cash account associated with the user ID.
